(19) United States
(12) Patent Application Publication
(10) Pub. No.: US 2005/0102979 A1
(43) Pub. Date: May 19, 2005

(54) Sheet body-processing apparatus

(75) Inventors: Hideyuki Uezono, Shizuoka-ken (JP); Hiroyuki Nishida, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/991,512

(22) Filed: Nov. 19, 2004

(30) Foreign Application Priority Data
Nov. 19, 2003 (JP) 2003-389246

(51) Int. Cl. B65B 11/00; B65B 49/00; G03G 15/00

(52) U.S. Cl. 53/513; 493/373; 53/209; 53/52

(57) ABSTRACT

A swinging conveyor is provided at a gate portion at an upstream side of a collection section. An X-ray film can be guided and discarded to a discard tray by this swinging conveyor. A light source and a light detector are provided between a first conveyor and a second conveyor at an upstream side of the swinging conveyor. Light of a predetermined wavelength is irradiated from the light source to an X-ray film which is being conveyed from the first conveyor to the second conveyor, and light that passes through the X-ray film is received by the light detector. A detection/control section judges whether or not an offcut is clinging to the X-ray film from amounts of light received by the light detector. If an offcut is clinging, the swinging conveyor operates to discard that X-ray film.

### CROSS-REFERENCE TO RELATED APPLICATION

This application claims priority under 35 USC 119 from Japanese Patent Application No. 2003-389246, the disclosure of which is incorporated by reference herein.

### BACKGROUND OF THE INVENTION

1. Field of the Invention

The present invention relates to a sheet body-processing apparatus which, when a web-form sheet material is being chopped to predetermined lengths to produce sheet bodies, cuts off corner portions of the sheet bodies to implement round corner-cutting.

2. Description of the Related Art

Photosensitive materials for medical purposes include an X-ray film in which a thermal development-type photosensitive material or the like is formed at a sheet body, and the like. Sheet bodies of an X-ray film or the like are formed by drawing out a web from a roll, which has been formed by being cut to a predetermined width, and cutting the web that is being drawn out to a predetermined length.

These sheet-form X-ray films are commercially produced with the four corners thereof having been cut off to implement round corner-cutting. In the corner-cutting of the X-ray films, the corner portions are cut, to be rounded, while the web is being conveyed and chopped to the predetermined length.

Now, when the corner-cutting of the X-ray films is performed, offcuts are generated. If an X-ray film is exposed with an image in a state in which an offcut is clinging to a surface of the X-ray film, a silhouette or the like of the offcut will appear in the image that is revealed after development, and accurate reproduction of the exposed image will be difficult. Moreover, when development and processing of an X-ray film is being carried out, if an offcut that is clinging to the X-ray film passes into an automatic development apparatus, it will cause a malfunction of the apparatus or the like.

Accordingly, it has been proposed to prevent offcuts from flying around and clinging to sheet films by connecting a suction system to a die which constitutes a lower blade for chopping the sheet films, and sucking and disposing of the offcuts with this suction system (see, for example, Japanese Patent Application Laid-Open (JP-A) No. 5-16099).

With this proposal, the occurrence of problems with product quality, such as chopping defects, poor cutting edges and the like, can be avoided by applying the suction immediately after contact of upper and lower blades at the time of chopping each sheet film.

However, the offcuts will not be completely eliminated just by suction thereof, and offcuts that are not sucked away may cling to the surfaces of the X-ray films. In other words, the offcuts will not necessarily be reliably removed simply by suctioning, and it may not be possible to prevent the offcuts from clinging to the surfaces of the X-ray films.

Further, when chopping and corner-cutting are implemented while X-ay film is being conveyed, if there are inconsistencies in the conveyance of the X-ray film, horn-like prominences may be formed at conveyance direction leading end sides of the X-ray films. Such prominences, as well as detracting from quality of appearance of the X-ray films, may cause problems with conveyance and the like of the X-ray films during image exposure, development processing and so forth, and may cause other problems, leading to deteriorations in product quality of the X-ray films.

### SUMMARY OF THE INVENTION

The present invention has been devised in consideration of the circumstances described above, and an object of the present invention is to provide a sheet body-processing apparatus which, when corner-cutting is being implemented during chopping to a predetermined length for fabricating sheet bodies of an X-ray film or the like, eliminates processing problems, such as the adherence of offcuts to the sheet bodies, the formation of protrusion portions and the like, and produces sheet bodies with high product quality.

A first aspect of the present invention for achieving the object described above is a sheet body-processing apparatus comprising: a first chopping section which, at a time at which a web is being conveyed while being chopped at intervals of a predetermined length for forming sheet bodies, chops two width direction end portions of a conveyance direction upstream side of each sheet body to circular arc forms for implementing corner-cutting; a second chopping section which chops two width direction end portions of a conveyance direction downstream end of the sheet body chopped by the first chopping section to circular arc forms for implementing corner-cutting; a conveyance section at which the sheet body chopped and formed by the first and second chopping sections is placed and conveyed; and a removal section provided to oppose the conveyance section, which removes a clinging body on the sheet body being conveyed by the conveyance section by blowing air toward the sheet body.

According to this invention, when the web is chopped by the first chopping section, the corner-cutting is implemented at both end portions in the width direction of the web that is being cut away (the sheet body). As a result, protrusion portions are left at both sides in the width direction at a leading end of the web. When the second chopping section implements corner-cutting at both end portions in the width direction of this leading end of the web, these protrusion portions are cut off. Hence, the cut-off protrusion portions become offcuts.

Here, in the first aspect of the present invention, the removal section is disposed to face the conveyance section on which the sheet body formed by the first and second chopping sections is placed and conveyed, and the removal section blows an airstream toward the sheet body being conveyed by the conveyance section.

Consequently, if an offcut has landed on an upper face of the sheet body, the offcut can be blown away from the upper face of the sheet body and removed. When the present invention is structured thus, it is also preferable to provide a suction section which, in time with the chopping of the second chopping section, sucks the offcuts that are generated at the time of chopping of the web by the second chopping section, and can thus prevent large numbers of offcuts from flying around.

In a second aspect of the present invention, the removal section includes a fan which blows air toward a surface of the sheet body being conveyed by the conveyance section and toward a conveyance direction upstream side.

According to this invention, when the airstream is blown toward the surface of the sheet body by the fan, the airstream is oriented toward the conveyance direction upstream side of the sheet body. Therefore, even if an offcut that has been removed from the surface of the sheet body lands on the sheet body, it can be blown away again. Thus, offcuts that have landed on the surface of the sheet body can be reliably removed, and it is possible to feed out sheet bodies on which no offcuts are placed.

In a third aspect of the present invention, a sheet body-processing apparatus includes: a first chopping section which, at a time at which a light-transmissive web is being conveyed while being chopped at intervals of a predetermined length for forming sheet bodies, chops two width direction end portions of a conveyance direction upstream side of each sheet body to circular arc forms for implementing corner-cutting; a second chopping section which chops two width direction end portions of a conveyance direction downstream end of the sheet body chopped by the first chopping section to circular arc forms for implementing corner-cutting; a conveyance section at which the sheet body chopped and formed by the first and second chopping sections is placed and conveyed; a light source which irradiates light of a predetermined wavelength toward the sheet body being conveyed by the conveyance section; a light-receiving portion which receives light that has been irradiated from the light source and transmitted through the sheet body, and outputs a signal in accordance with an amount of the received light; and a detection section which detects whether a clinging body has adhered to the sheet body on the basis of the amount of transmitted light received by the light-receiving portion.

According to this invention, when the sheet body is a film or the like featuring light transmissivity, the light is irradiated from the light source toward the sheet body and the transmitted light is received by the light-receiving portion. Here, the light source and the light-receiving portion may be capable of detection of variations in transmission amounts along the width direction of the sheet body.

On the basis of amounts of light received at the light-receiving portion, the detection section detects a clinging body, such as an offcut or the like, that has adhered to the sheet body. Here, the detection section detects a sheet body at which a clinging body is clinging from a variation in light transmission amounts caused by the clinging body.

Thus, sheet bodies at which offcuts are clinging are reliably detected, and it is possible to prevent sheet bodies to which offcuts have adhered from being fed out.

A sheet body-processing apparatus of a fourth aspect of the present invention further includes a disposal section which disposes of the sheet body in accordance with a result of detection of the detection section.

According to this invention, the disposal section discards sheet bodies detected by the detection section. Thus, feeding out of sheet bodies to which the offcuts, which are generated when the web is chopped by the first and second chopping sections, are clinging can be reliably prevented.

When the present invention is structured thus, the disposal section may include a disposal tray, at which disposed sheet bodies are collected, and a branching portion which switchingly branches a path of conveyance of the sheet body by the conveyance section toward the disposal tray, the branching portion operating in accordance with the result of detection of the detection section.

In a fifth aspect of the present invention, a sheet body-processing apparatus which includes: a first chopping section which, at a time at which a web is being conveyed while being chopped at intervals of a predetermined length for forming sheet bodies, chops two width direction end portions of a conveyance direction upstream side of each sheet body to circular arc forms for implementing corner-cutting; a second chopping section which chops two width direction end portions of a conveyance direction leading end of the sheet body chopped by the first chopping section to circular arc forms for implementing corner-cutting; a processing defect detection section which detects whether the sheet body includes a processing defect in which a residual uncut portion is formed at a conveyance direction leading end portion of the sheet body by the second chopping section; and a disposal section which disposes of the sheet body in accordance with a result of detection of the detection section.

According to this invention, if the chopping position of the second chopping section becomes irregular because of problems in conveyance of the web or the like, residual uncut portions are formed at the two width direction end portions at the leading end of the sheet body, and processing defects in which protrusion portions partially remain occur.

Accordingly, the processing defect detection section detects the residual uncut portions at the conveyance direction leading end of the sheet body, and the disposal section disposes of sheet bodies at which the residual uncut portions have been detected.

Thus, it is possible to reliably prevent sheet bodies at which protrusion portions are left from being fed out as processed products.

In the present invention that is structured thus, the processing defect detection section may include an image capture section which acquires an image of the conveyance direction leading end portion of the sheet body, and a judgement section which judges whether or not there is a residual uncut portion from the image captured by the image capture section.

According to this invention, an image of the leading end portion of the sheet body is captured using the image capture section. A sheet body at which residual uncut portions are present is detected from, for example, whether or not the captured image matches an image of a sheet body that has been chopped properly.

Further, if the present invention includes a collection section which aligns width direction central portions of the conveyance direction leading ends of the sheet bodies and collects the sheet bodies, the process defect detection section may detect whether or not a sheet body at which a residual uncut portion is formed is contained at the collection section by detection of the collected sheet bodies.

If such a case includes a wrapping section which wraps the sheet bodies that have been collected by the collection section for forming a wrapped body, the disposal section may include an extraction section which extracts the wrapped body formed by the wrapping section.

According to the sheet body-processing apparatus of the present invention as described above, because the removal section is provided to oppose the conveyance section on which the sheet body is placed and conveyed, it is possible to reliably remove offcuts and the like that have landed on the surfaces of the sheet bodies. Furthermore, with the sheet body-processing apparatus of the present invention, sheet bodies to which clinging bodies have adhered can be reliably detected and discarded.

Thus, excellent effects are provided in that it is possible to reliably discard sheet bodies to which offcuts and the like have adhered and to produce high product quality sheet bodies to which offcuts and the like are not adhered.

Moreover, the sheet body-processing apparatus of the present invention is capable of accurately discarding sheet bodies at which processing defects such as residual uncut portions and the like, which lead to conveyance problems and the like, have occurred.

### BRIEF DESCRIPTION OF THE DRAWINGS

FIG. 1 is a schematic structural drawing of a film production system at which a present embodiment is applied.

FIG. 2 is a perspective view of principal elements showing schematic structure of a chopping section.

FIG. 3A is a schematic view showing chopping of a web when an X-ray film is being produced, and particularly showing a chopping position vicinity of the web, which is being chopped to a predetermined length.

FIG. 3B is a schematic view showing the chopping of the web when the X-ray film is being produced, and particularly showing schematics of chopping of a leading end portion of the web that was being chopped in FIG. 3A.

FIG. 3C is a schematic view showing the chopping of the web when the X-ray film is being produced, and particularly showing the chopped web and the X-ray film.

FIG. 4 is a schematic perspective view showing an example of a removal apparatus provided at a conveyance section.

FIG. 5 is a schematic perspective view of principal elements, showing an example of a chip detection device and a gate section.

FIG. 6 is a graph showing an example of output of a detector provided at the chip detection device.

FIG. 7 is a schematic perspective view of principal elements, showing an example of a cover board application section.

FIG. 8 is a schematic view of a sheaf that includes an X-ray film at which horn portions are formed.

### DETAILED DESCRIPTION OF THE INVENTION

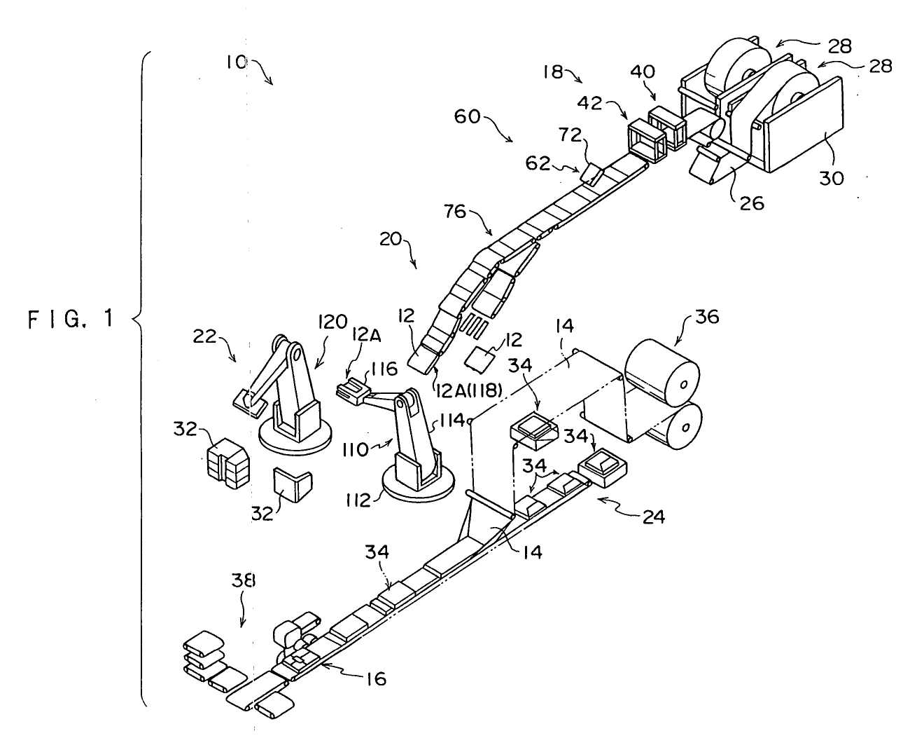

Below, an embodiment of the present invention will be described with reference to the drawings. FIG. 1 shows schematic structure of a film production system 10 at which the present embodiment is applied. This film production system 10 produces sheet-form X-ray films 12 with a predetermined size. The film production system 10 bundles the processed sheet-form X-ray films 12 in units of a predetermined number of sheets, implements lightproof wrapping with a wrapping material 14, and produces wrapped bodies 16 as finished products for shipping.

For the present embodiment, descriptions are given of the X-ray film 12, which is a kind of thermal development-type photosensitive material, as an example of a sheet body. This X-ray film 12 has an ordinary structure in which a photosensitive layer is formed at a surface of a light-transmissive support of PET or the like.

The wrapped bodies 16, which are produced by the film production system 10, are stacked and stored in a magazine or the like. When the wrapped bodies 16 (the X-ray films 12) are to be shipped, the wrapped bodies 16 are taken out from the magazine and packaged in units of predetermined numbers.

The film production system 10 includes a chopping section 18, a collection section 20 and a cover board application section 22. Further, a wrapping section 24 is provided in the film production system 10 at a downstream side of the cover board application section 22. The wrapped bodies 16, which are produced by the wrapping section 24, are loaded in an unillustrated magazine and conveyed to a storage space.

At an upstream side of the film production system 10, an original web of the X-ray film 12 is produced, a web 26 is formed by cutting the original web to a predetermined width, and the web 26 is wound up in the form of a roll to produce a slit roll 28. The slit roll 28 is put on a skid 30, conveyed in this state, and loaded at the chopping section 18 provided in the film production system 10.

The chopping section 18 draws out and conveys the web 26 from the slit roll 28 of this skid 30, and forms the sheet-form X-ray films 12 by chopping the web 26 to a predetermined length. That is, a width dimension of the slit roll 28 is a width dimension of the X-ray films 12 that are being produced and, because the web 26 is chopped in accordance with a length dimension (a dimension in a length direction) of the X-ray films 12 while being drawn out and conveyed in the length direction, the X-ray films 12 are produced with the predetermined width dimension and length dimension (i.e., the predetermined size).

The X-ray films 12 that have been formed by the chopping of the web 26 by the chopping section 18 are conveyed to the collection section 20. At the collection section 20, the X-ray films 12 are collected in an unillustrated tray in units of a pre-specified number of sheets (a number of sheets specified in accordance with the size, such as, for example, 50 to 200 sheets), and the X-ray films 12 form sheaves 12A.

At the cover board application section 22 which is disposed at the downstream side of the collection section 20, a cover board 32, which has been formed in a predetermined shape by being punched out of cardboard beforehand, is applied. At the cover board application section 22, the sheaf 12A formed by the X-ray films 12 being collected by the collection section 20 is taken out therefrom and covered up with the cover board 32. Thus, a volume 34 of the X-ray films 12 is formed.

The cover board application section 22 hands over the volume 34 of the X-ray films 12 to the wrapping section 24 with a predetermined timing.

A wrapping material roll 36, in which a long belt of the wrapping material 14 is wound up in a roll, is loaded at the wrapping section 24 in a state of being accommodated in an unillustrated container. The wrapping section 24 draws out the wrapping material 14 from this wrapping material roll 36.

The wrapping section 24 conveys the wrapping material 14, which has been drawn out from the wrapping material roll 36, and the volume 34 of the X-ray films 12, which has been supplied from the cover board application section 22, while wrapping the volume 34 in the wrapping material 14. Here, the wrapping section 24 superposes and joins two width direction end portions of the wrapping material 14 that has been wrapped round the volume 34, forming a center seal and thereby put the wrapping material 14 into a tubular state.

Then, the wrapping section 24 cuts the wrapping material 14 wrapped round the volume 34 at two ends, between which the volume 34 is disposed, and the cut ends are adhered. Thus, the volume 34 is hermetically sealed in the wrapping material 14. Further, a front fillet portion and a rear fillet portion formed at this time are folded over and unillustrated labels are stuck thereonto. Thus, the front fillet portion and rear fillet portion are sealed, and the wrapped body 16, in which the volume 34 of the X-ray films 12 is hermetically wrapped in the wrapping material 14, is produced.

An extraction section 38 is provided at a downstream side of the wrapping section 24. The extraction section 38 performs extraction or the like of wrapped bodies 16 which contain X-ray films 12 at which defects have occurred, wrapped bodies 16 to be used for sampling, and the like.

Now, at the chopping section 18, as shown in FIG. 1, cutters 40 and 42 are disposed as a pair in a conveyance direction of the web 26. Hereafter, a conveyance direction of the X-ray films 12, which is the conveyance direction of the web 26, is shown by the direction of an arrow A.

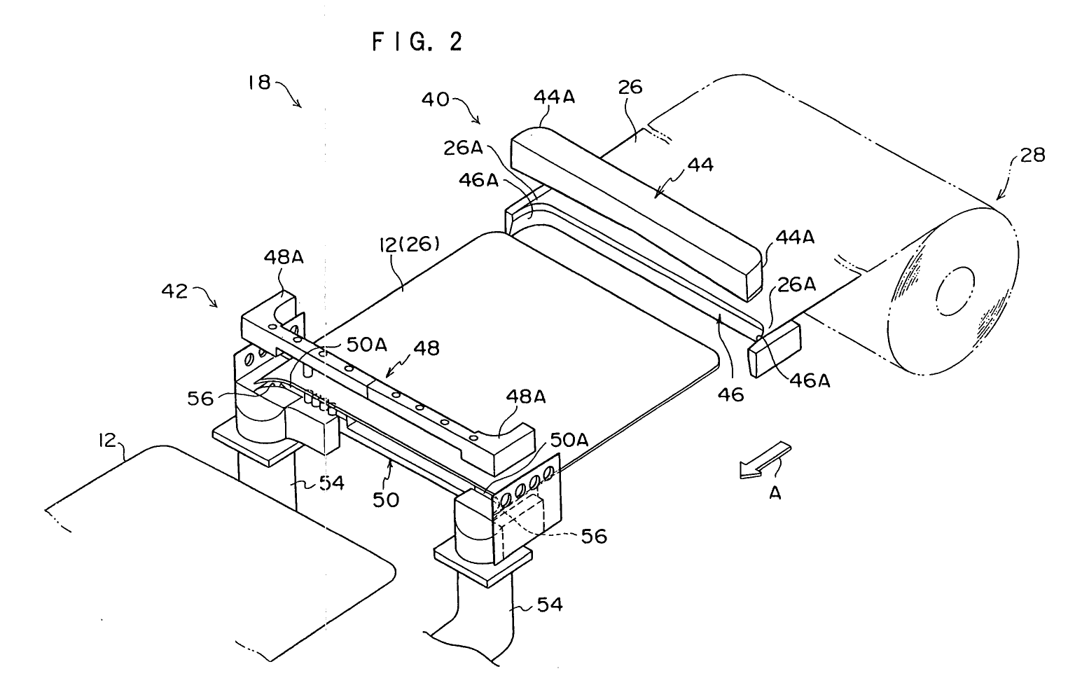

As shown in FIG. 2, the cutter 40 is formed with an upper blade 44 and a lower blade 46, and the cutter 42 is formed with an upper blade 48 and a lower blade 50. In the chopping section 18, the upper blades 44 and 48 are, for example, caused to rotate, with the lower blades 46 and 50 being caused to move reciprocatingly along the conveyance direction of the web 26, and the upper blade 44 and lower blade 46 and the upper blade 48 and lower blade 50 chop the web 26 at times of intersection thereof with a conveyance path of the web 26.

Thus, with the chopping section 18, chopping of the web 26 by the cutters 40 and 42 while the web 26 is being conveyed is possible.

The cutter 40 chops the web 26 along the width direction. Each time the web 26 has been conveyed at the chopping section 18 by a predetermined amount (an amount corresponding to the length of the X-ray films 12), the web 26 is chopped by the cutter 40. Thus, the X-ray films 12 with the predetermined size are produced.

At two end portions, of a conveyance direction upstream side of the web 26, of the upper blade 44 of this cutter 40, curving portions 44A which curve with a predetermined radius are formed. Meanwhile, at the two web 26 width direction end portions of the lower blade 46 of the cutter 40, curving portions 46A, which curve so as to protrude toward the conveyance direction downstream side, are formed to oppose the curving portions 44A of the upper blade 44.

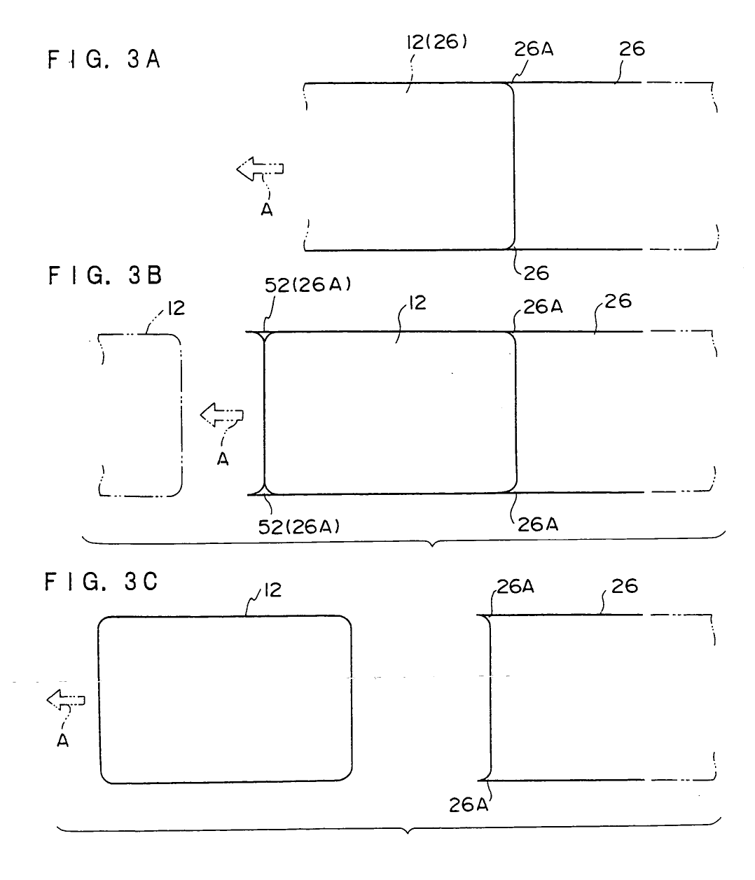

Hence, as shown in FIGS. 3A to 3C, at the two sides in the width direction of a leading end portion of the web 26, which has been chopped by the cutter 40 of the chopping section 18, protruding portions 26A, which protrude to the conveyance direction downstream side, are formed.

The web 26 that has been cut away by the cutter 40 has a substantially rectangular sheet form. Below, the portion that has been cut away by the cutter 40 is referred to with the term “the X-ray film(s) 12”.

Both width direction sides of a conveyance direction upstream side end portion of the X-ray film 12 that has been cut away from the web 26 by the cutter 40 are formed with circular arc shapes. In other words, corner-cutting is implemented at the conveyance direction upstream side end portion of the X-ray film 12 by the cutter 40.

As shown in FIG. 2, at the upper blade 48 of the cutter 42, blade portions 48A are respectively formed to oppose the two width direction end portions of the web 26 (the X-ray film 12). At the lower blade 50, blade portions 50A are formed to oppose the blade portions 48A of the upper blade 48.

Plan view shapes of the upper blade 48 are formed as ‘L’ shapes, being inflected toward the web 26 conveyance direction upstream side in recessed forms. Further, the blade portions 50A oppose the blade portions 48A, and web 26 conveyance direction downstream side faces of the blade portions 50A are inflected in protruding forms.

In the chopping section 18, the cutter 42 is operated at a time when the leading end portion of the web 26 that has been chopped by the cutter 40 opposes the cutter 42. That is, at the chopping section 18, the web 26 is chopped by the cutter 42 along the position of chopping by the cutter 40.

At this time, the two width direction end portions of the leading end portion of the web 26 are curved to a predetermined radius by the cutter 42.

Accordingly, as shown in FIGS. 3B and 3C, corner-cutting is implemented at the leading end of the web 26.

Thus, at the chopping section 18 provided in the film production system 10, the sheet-form X-ray film 12 at which corner-cutting has been implemented at all four corners is produced by chopping the web 26 to the predetermined length with the cutters 40 and 42.

Note that FIG. 3A shows a state in which a predetermined position of the web 26 has been chopped by the cutter 40, and FIG. 3B shows a state in which the web 26 has been chopped by the cutters 40 and 42. Further, at the chopping section 18, a speed of conveyance of the X-ray film 12 at a downstream side relative to the cutter 42 is faster than a speed of conveyance of the web 26 at an upstream side relative to the cutter 40. As a result, the X-ray film 12 that has been chopped by the cutters 40 and 42 is pulled away from the web 26. FIG. 3C shows a state in which the web 26 and X-ray film 12 chopped by the cutters 40 and 42 have been pulled apart.

Meanwhile, the protruding portions 26A, which have been formed at the web 26 by the cutter 40, are cut off from the web 26 (the X-ray film 12) by the cutter 42, and offcuts (chips) 52 are generated. In other words, the protruding portions 26A that are cut off from the web 26 by the cutter 42 become the offcuts 52.

Accordingly, as shown in FIG. 2, a pair of suction pipes 54 are connected with the lower blade 50 of the cutter 42 of the chopping section 18, and suction apertures 56 of the suction pipes 54 are opened in respective neighborhoods of the blade portions 50A.

Negative pressure generated by an unillustrated negative pressure source is supplied to the suction pipes 54. Consequently, the offcuts 52 can be sucked through the suction apertures 56.

The negative pressure is supplied to the suction pipes 54 to match times of operation of the cutter 42. Thus, the offcuts 52 that are generated by the operation of the cutter 42 are sucked through the suction apertures 56 while damage to cut edges, due to the cutter 42, conveyance of the X-ray film 12, or the like, is avoided.

As a result, occurrences of the offcuts 52 clinging to the X-ray film 12 and being carried out are suppressed. Note that the examples of the suction apertures 56 at the chopping section 18 employed in the present embodiment open in correspondence with the shapes of the protruding portions 26A (the offcuts 52) that are cut away by the cutter 42, so as not to apply suction over an unnecessarily wide range.

As shown in FIG. 1, a conveyance section 60 is provided at a downstream side of the chopping section 18, and the X-ray films 12 are conveyed through this conveyance section 60 and fed to the collection section 20.

At the conveyance section 60, a removal apparatus 62 is provided for removing the offcuts 52 that were generated when the X-ray film 12 was produced by chopping the web 26 with the cutters 40 and 42 and that have landed on the X-ray film 12 rather than being removed through the suction aperture 56.

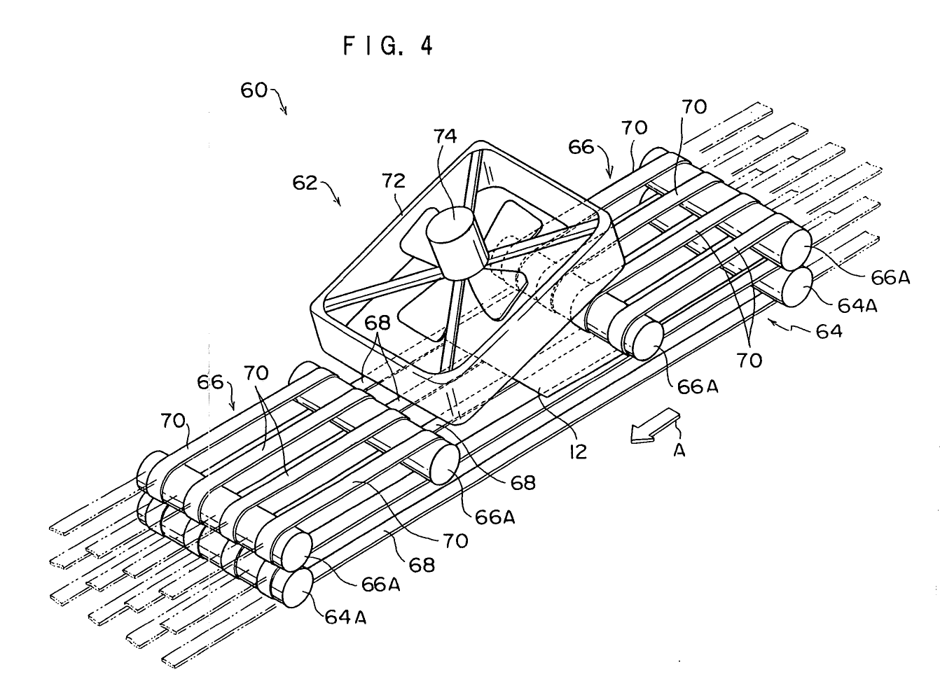

FIG. 4 shows an example of principal parts of the conveyance section 60. A conveyor 64 is provided in this conveyance section 60, and conveyors 66 are disposed to face the conveyor 64.

At the conveyor 64, endless conveyor belts 68 are wound between rollers 64A which are provided as a pair. At the conveyors 66, endless conveyor belts 70 are wound between rollers 66A which are provided as pairs. The conveyor belts 68 and 70 are driven to rotate by driving force of an unillustrated driving section.

At the conveyor 64, a plurality of the conveyor belts 68 are provided along an axial direction of the rollers 64A. At the conveyors 66, the conveyor belts 70 are provided to respectively oppose the conveyor belts 68.

Accordingly, at the conveyance section 60, the X-ray film 12 that is fed out from the chopping section 18 is nipped between the conveyor belts 68 of the conveyor 64 and the conveyor belts 70 of the conveyors 66, and the conveyor belts 68 and 70 are driven to rotate. Thus, the X-ray film 12 is conveyed.

The conveyors 66 are disposed apart by a predetermined spacing along the conveyance direction of the X-ray films 12, and the conveyor belts 68 of the conveyor 64 are exposed between the upstream side conveyor 66 and the downstream side conveyor 66. That is, the conveyors 66 are disposed to oppose an upstream portion and a downstream portion of the conveyor 64 and, between the conveyors 66, the X-ray film 12 is lain and conveyed on the conveyor belts 68.

Here, the spacing mentioned above is a little shorter than the length of the X-ray film 12. Therefore, the X-ray film 12 is nipped between the conveyor belts 68 of the conveyor 64 and the conveyor belts 70 of either of the upstream side and downstream side conveyors 66, and can be reliably conveyed.

The removal apparatus 62 is equipped with a fan 72. This fan 72 is disposed to face the conveyor belts 68 of the conveyor 64 between the conveyors 66.

When this fan 72 is driven by a motor 74, the fan 72 blows an airstream toward the conveyor belts 68 of the conveyor 64. As a result, the X-ray film 12 on the conveyor belts 68 is pressed against the conveyor belts 68 by the airstream blown from the fan 72. At the same time, if any of the offcuts 52 have landed on an upper face of the X-ray film 12, that offcut 52 is blown away and removed from the surface of the X-ray film 12.

The fan 72 is inclined a little toward the conveyance direction upstream side of the X-ray film 12 for blowing the airstream. Therefore, even if the offcut 52 that was clinging to the X-ray film 12 returns to cling thereto again, the offcut 52 can be blown away by the fan 72 again and clinging of the offcut 52 to the X-ray film 12 so as to be carried out to the downstream side is reliably prevented. In the present embodiment, as an example, the fan 72 is disposed so as to blow the airstream at an angle of approximately 20° relative to the surface of the X-ray film 12.

Thus, at the conveyance section 60, the X-ray films 12 are conveyed toward the collection section 20 while removal of the offcuts 52 that have adhered to the surfaces of the X-ray films 12 is achieved.

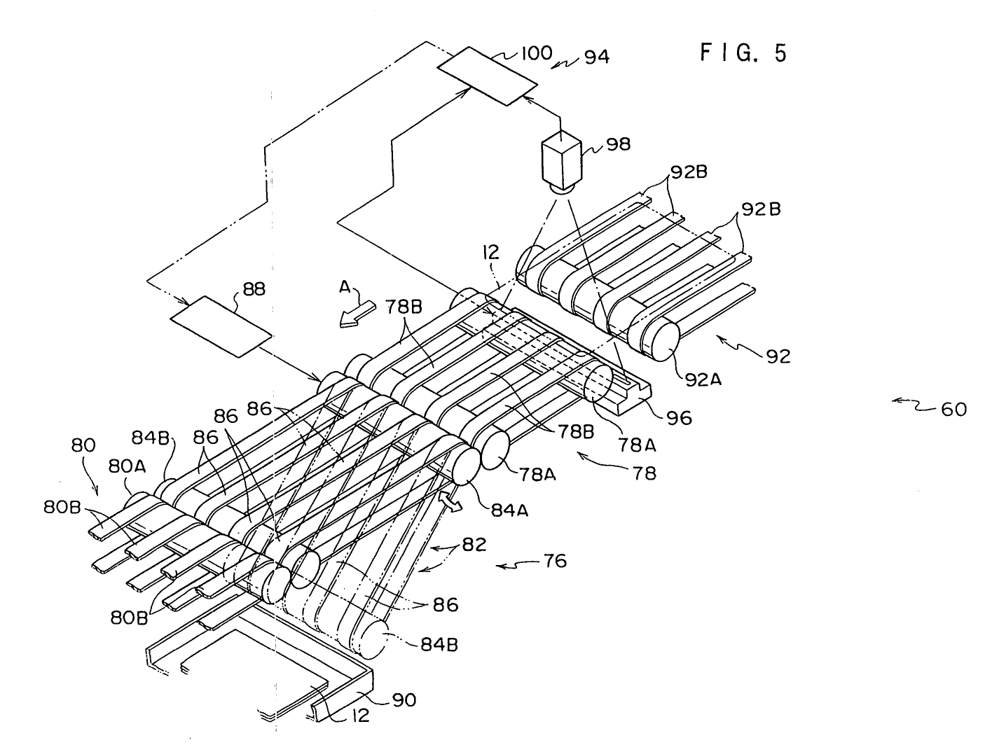

As shown in FIG. 1, a gate section 76, which forms a branching portion, is provided at an upstream side of the collection section 20. FIG. 5 shows general structure of a vicinity of the gate section 76.

At the gate section 76, a swinging conveyor 82 is provided between conveyors 78 and 80, which form a conveyance path of the X-ray films 12. At the swinging conveyor 82, endless conveyor belts 86 are wound between rollers 84A and 84B, which are provided as a pair. The X-ray films 12 which are fed in from the conveyor 78 are placed on the conveyor belts 86 and conveyed, and can be fed out to the conveyor 80.

Here, the swinging conveyor 82, the conveyor 78 and the conveyor 80 have ordinary structures in which, for example: at the conveyor 82, a plurality of the conveyor belts 86 are disposed with a predetermined spacing along an axial direction of the rollers 84A and 84B; at the conveyor 78, a plurality of conveyor belts 78B are wound between rollers 78A which are provided as a pair; and at the conveyor 80, a plurality of conveyor belts 80B are wound between rollers 80A which are provided as a pair (of which one is not shown in the drawing).

A swinging portion 88 is provided at the swinging conveyor 82. The swinging portion 88 swings the swinging conveyor 82 through a predetermined angle around the axis of the roller 84A such that the roller 84B moves downward (see the broken lines in FIG. 5).

Further, a discard tray 90 is provided at the gate section 76 to oppose the swinging conveyor 82 that has swung downward.

Thus, when the swinging conveyor 82 is swung, the X-ray films 12 that are fed from the conveyor 78 to the swinging conveyor 82 are guided to and collected in the discard tray 90 by the swinging conveyor 82. Here, the swinging portion 88 operates, for example, when any of the X-ray films 12 that include defects of the web 26, which were detected before or during production of the slit roll 28, is fed to the swinging conveyor 82, such that the X-ray films 12 at which there are defects are collected in the discard tray 90.

A conveyor 92 is disposed at an upstream side of the conveyor 78. Here, the conveyor 92 may employ an ordinary structure in which a plurality of conveyor belts 92B are wound between rollers 92A which are provided as a pair (one of which is not shown in FIG. 5). The conveyor 64 mentioned above may be employed as this conveyor 92.

A predetermined gap is provided between the conveyors 78 and 92. The X-ray films 12 that are conveyed by the conveyor 92 pass through this gap and are handed over to the conveyor 78.

A chip detection device 94 is provided between the conveyors 78 and 92. This chip detection device 94 is equipped with a light source 96, a light detector 98 and a detection and control section 100. The light detector 98 receives light emitted from the light source 96, and the detection and control section 100 controls the light source 96 and the light detector 98.

The light source 96 is disposed between the conveyors 78 and 92 at a side below the conveyance path of the X-ray films 12, with a length direction of the light source 96 along the width direction of the X-ray films 12, which is a direction intersecting the conveyance direction of the X-ray films 12. The light source 96 emits light of a predetermined wavelength from, for example, a slit-form emission aperture along the width direction of the X-ray films 12.

Thus, the light source 96 irradiates the light emitted therefrom along the width direction of the X-ray film 12 so as to pass between the conveyors 78 and 92.

This light source 96 emits light with a peak at a wavelength of 950 nm, which is light for which the X-ray film 12 has relatively little photosensitivity. Specifically, the X-ray film 12, which is the thermal development-type photosensitive material for medical purposes that is being processed by the film production system 10, has peaks of photosensitivity in the visible light region, at wavelengths between 300 and 400 nm and between 500 and 600 nm. Therefore, the light source 96 whose peak wavelength is 950 nm is used.

Note that the wavelength of the light emitted from the light source 96 is not limited thus, and light of arbitrary wavelengths can be employed as long as the X-ray film 12 does not exhibit photosensitivity to that light. The light detector 98 is disposed between the conveyors 78 and 92 at a side above the conveyance path of the X-ray films 12, to oppose the light source 96. Furthermore, the X-ray film 12 employs the light-transmissive support.

Therefore, the light that is irradiated from the light source 96 passes through the X-ray film 12 and is received at the light detector 98.

The light detector 98 employs a CCD camera or the like having a region of sensitivity to light of the wavelength emitted from the light source 96. The light detector 98 receives the light that has been emitted from the light source 96 and transmitted through the X-ray film 12. Hence, electronic signals corresponding to amounts of light received by the light detector 98 are inputted to the detection and control section 100.

Here, by reading in from the light detector 98 to the detection and control section 100, for example, an image along the width direction of the X-ray film 12, it is possible to detect amounts of light transmitted at arbitrary positions along the width direction of the X-ray film 12. Note that, for this structure, it is possible to use a CCD line sensor as the light detector 98, and it is possible for the light source 96 to be a component which irradiates light while scanning along the width direction of the X-ray film 12.

The X-ray film 12 absorbs small amounts of light. Accordingly, as well as the amounts of light received at the light detector 98 varying in accordance with the presence or absence of the X-ray film 12, the amounts of light received at the light detector 98 also vary in accordance with the thickness of the X-ray film 12, the presence or absence of a clinging body on the X-ray film 12, and the like.

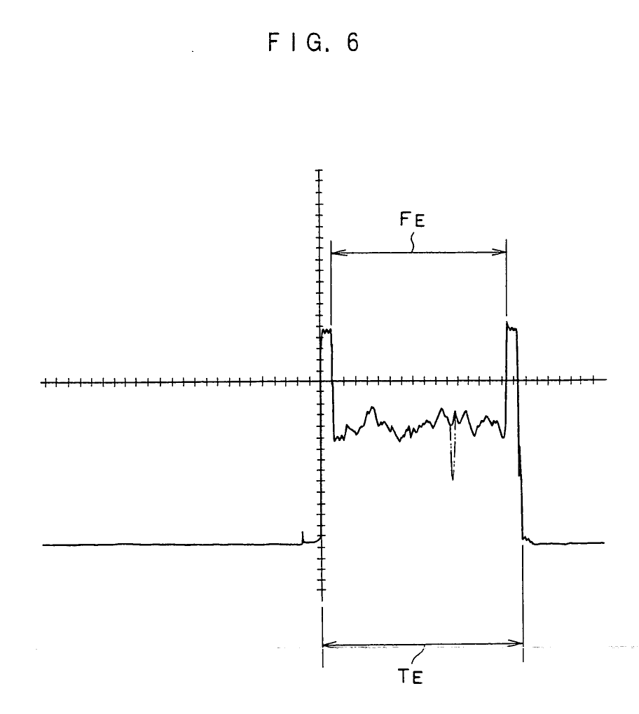

FIG. 6 shows an outline of amounts of light received at the light detector 98 at a predetermined position along the conveyance direction of the X-ray film 12. Note that in FIG. 6 the vertical axis represents light amount and the horizontal axis represents position along the width direction of the X-ray film 12, the region TE is a range in which light emitted from the light source 96 is detected by the light detector 98, and the region FE corresponds to the X-ray film 12.

As shown in FIG. 6, the amounts of received light detected by the light detector 98 are reduced by the X-ray film 12 entering between the light source 96 and the light detector 98. Therefore, it is possible for the detection and control section 100 to judge whether or not the X-ray film 12 is passing through.

Here, if there are no clinging bodies and the like on the surface of the X-ray film 12, variations along the width direction of the X-ray film 12 of the received light amounts at the light detector 98 will be small (i.e., the amounts are substantially constant).

On the other hand, if one of the offcuts 52 or the like clings to the surface of the X-ray film 12, light transmissivity is reduced for that portion and, correspondingly, amounts of light received at the light detector 98 fall. That is, when the offcut 52 has landed on the surface of the X-ray film 12, received light amounts for the corresponding portion are greatly reduced, as shown by the broken line in FIG. 6.

In the film production system 10, the swinging portion 88 is operated, as shown in FIG. 5, in accordance with results of judgement by the detection and control section 100, which is to say a detection result when the offcut 52 or the like that is clinging to the X-ray film 12 is detected. In such a case, the swinging portion 88 swings the swinging conveyor 82 at a time at which the leading end of the corresponding X-ray film 12 will reach the swinging conveyor 82, and the X-ray film 12 for which adherence of the offcut 52 or the like has been detected is guided to and collected in the discard tray 90.

Thus, in the film production system 10, only the X-ray films 12 for which defects, problems and the like have not been detected and that have passed the swinging conveyor 82 are fed to and collected in the collection section 20.

Note that the collection section 20 can employ an arbitrary structure for sequentially stacking the X-ray films 12 in units of the predetermined number of sheets, and descriptions of the collection section 20 are not given for the present embodiment.

At the cover board application section 22, the sheaf 12A of the X-ray films 12 that have been stacked and formed are taken out from the collection section 20, this sheaf 12A is covered with the cover board 32, and the volume 34 is produced.

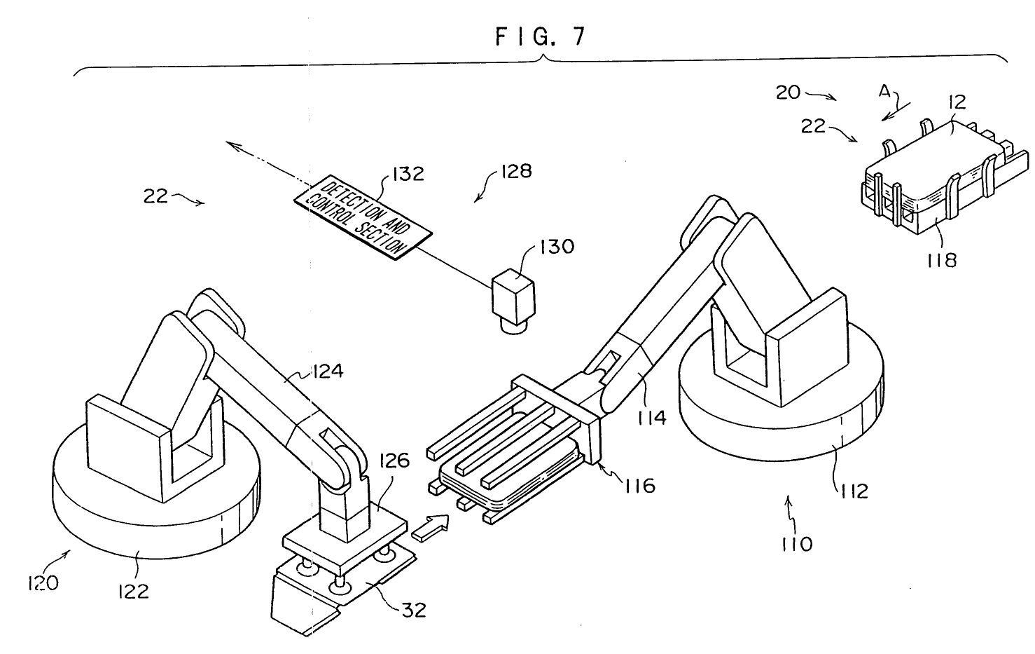

FIG. 7 shows an example of the cover board application section 22. This cover board application section 22 is equipped with a sheet-handling robot 110. This sheet-handling robot 110 is a general-purpose multi-axis robot equipped with a pedestal 112, an arm 114 and a chuck 116. The arm 114 is mounted on the pedestal 112 and is rotatable and flexible relative to the pedestal 112. The chuck 116 is attached to a distal end of the arm 114 and is capable of gripping and retaining the sheaf 12A of the X-ray films 12.

This sheet-handling robot 110 grips and takes out the sheaf 12A of the X-ray films 12, which have been collected in a tray 118 of the collection section 20, with the chuck 116.

At the tray 118, a stopper 118A is provided facing, for example, a leading end of a side of the X-ray films 12 in the conveyance direction (the direction of arrow A). This stopper 11 8A opposes a width direction central portion of the X-ray films 12. The length directions of the X-ray films 12 are aligned, with the conveyance direction leading ends at a reference position, by the conveyance direction leading ends of the X-ray films 12 abutting against the stopper 11 8A. Herein, the tray 118 also aligns the width directions of the X-ray films 12, and it is possible to employ an arbitrary structure for this tray 118.

Hence, the sheet-handling robot 110 grasps the X-ray films 12 with the chuck 116 such that the leading ends of the X-ray films 12 are at a predetermined position.

Meanwhile, as shown in FIGS. 1 and 7, a cover-handling robot 120 is provided at the cover board application section 22. As shown in FIG. 7, the cover-handling robot 120 is a general-purpose multi-axis robot which is provided, on a pedestal 122, with an arm 124 which is rotatable and flexible relative to the pedestal 122. A suction pad 126, which is equipped with a plurality of suckers, is provided at a distal end of the arm 124.

The cover-handling robot 120 suckingly retains and takes out one of the cover boards 32, which have been stacked and loaded at the cover board application section 22, with the suction pad 126. Provisional folding of the cover board 32 that is suction-adhered by the suction pad 126 is implemented, using the cover-handling robot 120 and an unillustrated provisional folding mechanism, for folding up the cover board 32 into a half-box shape.

The cover-handling robot 120 suction-adheres the provisionally folded cover board 32 with the suction pad 126 and hands the cover board 32 over to the sheet-handling robot 110, which is retaining the sheaf 12A of the X-ray films 12.

At this time, the cover-handling robot 120 hands over the cover board 32 to the sheet-handling robot 110 such that the sheaf 12A is superposed with a predetermined position of the cover board 32, and the sheet-handling robot 110 superposingly grips the cover board 32 with the sheaf 12A.

Then, the cover board 32 is folded up into the half-box shape along the provisional folding positions by an unillustrated folding-out mechanism at the cover board application section 22. Thus, the volume 34, in which the sheaf 12A of the X-ray films 12 is protected by the cover board 32, is formed.

The sheet-handling robot 110 conveys this volume 34 to a predetermined position of the wrapping section 24 and supplies the volume 34 to the wrapping section 24 (see FIG. 1).

Now, a defect detection apparatus 128, which detects defects of chopping of the X-ray films 12, is provided at the cover board application section 22. This defect detection apparatus 128 is equipped with a CCD camera 130 and a detection and control section 132. The CCD camera 130 is disposed at a predetermined position of the cover board application section 22, and the detection and control section 132 detects any of the X-ray films 12 at which chopping defects have occurred from images captured by the CCD camera 130.

The sheet-handling robot 110 causes the sheaf 12A that has been taken out from the tray 118 of the collection section 20 to oppose the CCD camera 130. Here, the sheet-handling robot 110 causes conveyance direction leading end portions of the X-ray films 12 to oppose the CCD camera 130.

The detection and control section 132 acquires an image of an edge portion of the sheaf 12A opposing the CCD camera 130 and determines whether or not the shape of the edge portion of any of the X-ray films 12 is abnormal by, for example, comparing the acquired image with a reference image that has been stored beforehand. Here, the defect detection apparatus 128 is equipped with an unillustrated light source, which emits light of a wavelength in a region for which photosensitivity of the X-ray films 12 is low. The image of the edge portion of the sheaf 12A is acquired by detecting light emitted from this light source that has been either transmitted or reflected.

In the film production system 10, when the web 26 is being chopped by the cutters 40 and 42 of the chopping section 18, if there is a problem with conveyance of the web 26, a proper position of the leading end portion of the web 26 will not oppose the cutter 42.

At such a time, if the conveyance amount of the web 26 is too small, the protruding portions 26A will not be properly chopped off when corner-cutting is implemented at the leading end of the web 26 (the X-ray film 12) by the cutter 42.

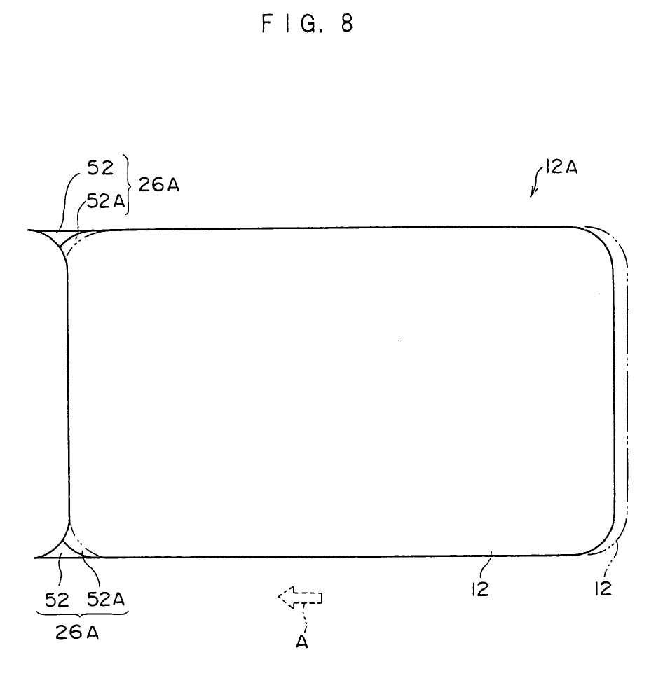

Hence, as shown in FIG. 8, horn portions 52A, which are portions of the protruding portions 26A that are left, are formed at the X-ray film 12. These horn portions 52A protrude from the sheaf 12A in which the leading end portions of the X-ray films 12 are aligned and collected.

That is, if the X-ray film 12 at which the horn portions 52A have been formed (as shown by solid lines in FIG. 8) is present among the X-ray films 12 that have been chopped to the proper length (as shown by broken lines in FIG. 8), the horn portions 52A will protrude from the sheaf 12A.

The defect detection apparatus 128 provided at the cover board application section 22 acquires the shape of the edge portion of the sheaf 12A from the image captured by the CCD camera 130, and determines whether the horn portions 52A are present or absent from the shape of the acquired edge portion.

As shown in FIG. 1, in the film production system 10, the extraction section 38 is provided at the downstream side of the wrapping section 24. When the defect detection apparatus 128 detects one of the X-ray films 12 at which a chopping defect has occurred, that is, the sheaf 12A including the X-ray film 12 at which the horn portions 52A are formed, the wrapped body 16 of that sheaf 12A is extracted by the extraction section 38.

Thus, the wrapped body 16 containing the X-ray film 12 at which the horn portions 52A are formed is reliably prevented from being made into a finished product and shipped.

In the film production system 10 which is structured thus, when the slit roll 28 is loaded at the chopping section 18, the web 26 is drawn out from this slit roll 28, the web 26 is chopped to the predetermined length by the cutters 40 and 42, and the X-ray films 12 of the predetermined size are formed.

These X-ray films 12 are conveyed through the conveyance section 60 and fed to the collection section 20, hence being accumulated in units of the predetermined number of sheets in the tray 118.

At the cover board application section 22, the sheaf 12A of the X-ray films 12 that have been collected in the tray 118 is taken out by the sheet-handling robot 110, is superposed with the cover board 32 that has been taken out and provisionally folded by the cover-handling robot 120, and the volume 34 in which the sheaf 12A is protected by the cover board 32 is formed.

This volume 34 is handed over to the wrapping section 24 by the sheet-handling robot 110.

At the wrapping section 24, while the wrapping material 14 that is drawn out from the wrapping material roll 36 is being conveyed with the volume 34, the volume 34 is wrapped in the wrapping material 14 and, by cutting and joining of this wrapping material 14, the wrapped body 16, in which the volume 34 is hermetically wrapped in the wrapping material 14, is produced.

The wrapped body 16 that is produced in this manner is packaged in units of predetermined numbers and shipped. That is, after the X-ray films 12 have been hermetically wrapped in units of the predetermined number of sheets, the X-ray films 12 are packaged and shipped.

In the film production system 10, corner-cutting is implemented when the X-ray film 12 is being produced by the chopping section 18. Here, suction is applied when the protruding portions 26A, which are formed when the web 26 is chopped by the cutter 40, are chopped off by the cutter 42. Thus, the protruding portions 26A are prevented from flying around in the form of the offcuts 52, and adherence of these offcuts 52 to the X-ray films 12 is suppressed.

However, some of these offcuts 52 may adhere to the X-ray films 12 and be carried out from the chopping section 18.

Accordingly, in the film production system 10, the removal apparatus 62 is provided at the conveyance section 60 between the chopping section 18 and the collection section 20, and a wind generated by the fan 72 is blown at the surfaces of the X-ray films 12, which are laid on the conveyor 64 and conveyed.

As a result, in cases in which the offcuts 52 have landed on the surfaces of the X-ray films 12, these offcuts 52 can be reliably removed from the X-ray films 12. At such times, because the airstream is blown by the fan 72 so as to be directed toward the upstream side of the X-ray films 12, even if one of the offcuts 52 that have been blown off by this airstream clings to the X-ray film 12 again, the offcut 52 can be blown off again. Thus, reliable removal of the offcuts 52 that have landed on the surfaces of the X-ray films 12 is possible.

Now, in the present embodiment, the airstream generated by the fan 72 is blown at the surfaces of the X-ray films 12. However, the airstream generated by the fan 72 may, rather than being blown at the surfaces of the X-ray films 12 directly, be blown at the surfaces of the X-ray films 12 via a duct or the like.

Further, rather than a simple wind, an airstream containing ions (an ion wind) may be blown at the surfaces of the X-ray films 12. Accordingly, removal of any of the offcuts 52 that are adhered to the X-ray films 12 by static electricity or the like is possible.

However, in cases in which the offcuts 52 are firmly stuck to the X-ay films 12, the offcuts 52 may not be completely removed by the fan 72.

Accordingly, the chip detection device 94 is provided in the film production system 10, together with the gate section 76, at the upstream side of the collection section 20.

At the chip detection device 94, the light emitted from the light source 96 is irradiated toward the X-ray film 12 being conveyed from the conveyor 92 to the conveyor 78, transmitted light is received by the light detector 98, and signals corresponding to the received light amounts are outputted to the detection and control section 100.

The detection and control section 100 judges whether or not any of the offcuts 52 are clinging to the X-ray film 12 from the received light amounts of the light detector 98.

That is, as shown in FIG. 6, when the offcuts 52 are not clinging to the X-ray film 12, light amounts in the region FE are substantially constant. In contrast, when one of the offcuts 52 is clinging thereto, a light amount that is transmitted at the corresponding position is lower. The detection and control section 100 judges whether or not the offcuts 52 are clinging to the X-ray films 12 accordingly.

Here, when it is judged that one of the offcuts 52 is clinging to the X-ay film 12, the swinging portion 88 is operated to swing the swinging conveyor 82 at the time at which that X-ray film 12 reaches the swinging conveyor 82, and the X-ray films 12 that have been judged to have the offcuts 52 clinging thereto are gathered into the discard tray 90.

As a result, it is possible to collect only the X-ray films 12 to which the offcuts 52 are not adhered in the collection section 20. That is, it is possible to reliably prevent the X-ray films 12 to which the offcuts 52 are clinging, or any of the wrapped bodies 16 that contain such X-ray films 12, from being shipped as finished products.

Meanwhile, at the chopping section 18, when the web 26 is being chopped to the predetermined length while corner-cutting is being implemented using the cutters 40 and 42, if there is a problem in conveyance of the web 26, the protruding portions 26A may partially remain, and the horn portions 52A may occur at the X-ray film 12.

Accordingly, in the film production system 10, the defect detection apparatus 128 is provided at the cover board application section 22. The defect detection apparatus 128 is equipped with the CCD camera 130. In the cover board application section 22, the leading end portion of the sheaf 12A of the X-ray films 12 that has been taken out from the tray 118 by the sheet-handling robot 110 is caused to oppose the CCD camera 130.

At the collection section 20, the width direction central portions of the conveyance direction leading ends of the X-ray films 12 are aligned and the X-ray films 12 are stacked in the tray 118. Consequently, if the horn portions 52A are present at any of the X-ray films 12, these horn portions 52A will protrude from the edge portion of the sheaf 12A.

The detection and control section 132 judges whether or not there are any of the X-ray films 12 at which the horn portions 52A are formed from the image of the edge portion of the sheaf 12A that is captured by the CCD camera 130.

Here, in the film production system 10, when the defect detection apparatus 128 detects the horn portions 52A, the sheaf 12A of the corresponding X-ray film 12 is tracked, and when the wrapped body 16 formed by wrapping that sheaf 12A in the wrapping material 14 reaches the extraction section 38, that wrapped body 16 is extracted.

As a result, it is possible to reliably prevent the X-ray films 12 at which processing failures have occurred, and the wrapped bodies 16 containing these X-ray films 12, from being shipped as finished products.

Thus, with the film production system 10, the X-ray films 12 to which the offcuts 52 generated at the time of chopping of the web 26 are adhered and the X-ray films 12 at which the horn portions 52A are formed can be reliably prevented from being produced as finished products, and the X-ray films 12 that have been processed to high product quality can be produced.

In the present embodiment, the defect detection apparatus 128 is provided at the cover board application section 22. However, the present invention is not limited thus. For example, the defect detection apparatus 128 could be provided such that the CCD camera 130 opposes the tray 118 of the collection section 20.

Further, in the present embodiment described above, an example of the present invention has been illustrated, but structures of the present invention are not limited to this. For example, in the present embodiment, an example of a film production system 10 which produces the X-ray films 12 as the sheet bodies has been described. However, the removal apparatus 62, the defect detection apparatus 128 are not limited thus, and application thereof to processing apparatuses for arbitrary sheet bodies, such as printing paper, various kinds of recording material, etc., is possible. Further still, the chip detection device 94 can be applied to sheet body-processing apparatuses with arbitrary structures for producing light-transmissive sheet bodies.

1. A sheet body-processing apparatus comprising:
a first chopping section which, at a time at which a web is being conveyed while being chopped at intervals of a predetermined length for forming sheet bodies, chops two width direction end portions of a conveyance direction upstream side of each sheet body to circular arc forms for implementing corner-cutting;
a second chopping section which chops two width direction end portions of a conveyance direction downstream end of the sheet body chopped by the first chopping section to circular arc forms for implementing corner-cutting;
a conveyance section at which the sheet body chopped and formed by the first and second chopping sections is placed and conveyed; and
a removal section provided to oppose the conveyance section, which removes a clinging body on the sheet body being conveyed by the conveyance section by blowing air toward the sheet body.

2. The sheet body-processing apparatus of claim 1, wherein the removal section comprises a fan which blows air toward a surface of the sheet body being conveyed by the conveyance section and toward a conveyance direction upstream side.

3. A sheet body-processing apparatus comprising:
a first chopping section which, at a time at which a light-transmissive web is being conveyed while being chopped at intervals of a predetermined length for forming sheet bodies, chops two width direction end portions of a conveyance direction upstream side of each sheet body to circular arc forms for implementing corner-cutting;
a second chopping section which chops two width direction end portions of a conveyance direction downstream end of the sheet body chopped by the first chopping section to circular arc forms for implementing corner-cutting;
a conveyance section at which the sheet body chopped and formed by the first and second chopping sections is placed and conveyed;
a light source which irradiates light of a predetermined wavelength toward the sheet body being conveyed by the conveyance section;
a light-receiving portion which receives light that has been irradiated from the light source and transmitted through the sheet body, and outputs a signal in accordance with an amount of the received light; and
a detection section which detects whether a clinging body has adhered to the sheet body on the basis of the amount of transmitted light received by the light-receiving portion.

4. The sheet body-processing apparatus of claim 3, further comprising a disposal section which disposes of the sheet body in accordance with a result of detection of the detection section.

5. The sheet body-processing apparatus of claim 4, wherein the disposal section comprises a disposal tray, at which disposed sheet bodies are collected, and a branching portion which switchingly branches a path of conveyance of the sheet body by the conveyance section toward the disposal tray, the branching portion operating in accordance with the result of detection of the detection section.

6. A sheet body-processing apparatus comprising:
a first chopping section which, at a time at which a web is being conveyed while being chopped at intervals of a predetermined length for forming sheet bodies, chops two width direction end portions of a conveyance direction upstream side of each sheet body to circular arc forms for implementing corner-cutting;
a second chopping section which chops two width direction end portions of a conveyance direction leading end of the sheet body chopped by the first chopping section to circular arc forms for implementing corner-cutting;
a processing defect detection section which detects whether the sheet body includes a processing defect in which a residual uncut portion is formed at a conveyance direction leading end portion of the sheet body by the second chopping section; and
a disposal section which disposes of the sheet body in accordance with a result of detection of the detection section.

7. The sheet body-processing apparatus of claim 6, wherein the processing defect detection section comprises an image capture section which acquires an image of the conveyance direction leading end portion of the sheet body, and a judgement section which judges whether or not there is a residual uncut portion from the image captured by the image capture section.

8. The sheet body-processing apparatus of claim 6, further comprising a collection section which aligns width direction central portions of the conveyance direction leading ends of the sheet bodies and collects the sheet bodies, the process defect detection section detecting whether or not a sheet body at which a residual uncut portion is formed is contained at the collection section by detection of the collected sheet bodies.

9. The sheet body-processing apparatus of claim 7, further comprising a collection section which aligns width direction central portions of the conveyance direction leading ends of the sheet bodies and collects the sheet bodies, the process defect detection section detecting whether or not a sheet body at which a residual uncut portion is formed is contained at the collection section by detection of the collected sheet bodies.

10. The sheet body-processing apparatus of claim 8, further comprising a wrapping section which wraps the sheet bodies collected by the collection section for forming a wrapped body, wherein the disposal section includes an extraction section which extracts the wrapped body formed by the wrapping section in accordance with a result of detection by the processing defect detection section.

11. The sheet body-processing apparatus of claim 9, further comprising a wrapping section which wraps the sheet bodies collected by the collection section for forming a wrapped body, wherein the disposal section includes an extraction section which extracts the wrapped body formed by the wrapping section in accordance with a result of detection by the processing defect detection section.

12. The sheet body-processing apparatus of claim 1, further comprising a suction section that, in time with the chopping of the second chopping section, sucks the offcuts that are generated at the time of chopping of the web by the second chopping section.

13. The sheet body-processing apparatus of claim 2, further comprising a suction section that, in time with the chopping of the second chopping section, sucks the offcuts that are generated at the time of chopping of the web by the second chopping section.

14. The sheet body-processing apparatus of claim 3, wherein, the light source and the light-receiving portion are capable of detection of variations in transmission amounts along the width direction of the sheet body.
